(19) United States
(12) Patent Application Publication
(10) Pub. No.: US 2006/0230446 A1
(43) Pub. Date: Oct. 12, 2006

(54) Hybrid SSL/IPSec network management system

(76) Inventor: Lan Ngoc Vu, Round Rock, TX (US)

Correspondence Address: J. V. Myers & Associates, PC, P.O. Box 130, Driftwood, TX, 78619, US

(21) Appl. No.: 11/100,304

(22) Filed: Apr. 6, 2005

(51) Int. Cl. G06F 15/16

(52) U.S. Cl. 726/15

(57) ABSTRACT

System and method for operating, via the Internet, a distributed network in which an SSL VPN is employed to establish and manage an IPSec VPN. During network creation, an SSL VPN is first established between a master server and each node. Using a common routing table and a common SSL key table maintained by the master server, each node may selectively establish an IPSec VPN with other nodes. Once established, each node maintains a respective segment of a distributed IPSec key table. Periodically, each client and each server, other than the master server, cooperates with the master server to refresh the master and local copies of the common routing and common SSL key tables, and the local segment of the distributed IPSec key table. In the event a change has occurred in either the routing or key information for any server, all pending IPSec VPN connections with that server must be reestablished, using the information in the refreshed local copies of the common routing and common SSL key tables The master server controls the network configuration by assigning to each node permissible IPSec connections. By updating and maintaining copies of the common routing and common SSL key tables at multiple nodes in the network, and local segments of the distributed IPSec key table, the network can quickly recover and rebuild itself in the event that an SSL or IPSec connection with any node is lost.

### CROSS-REFERENCE TO RELATED APPLICATIONS

The present invention is related to the followmg co-pending applications for patents (the “Related Applications”):

“System and Method for Facilitating Business-to-Business Business”, U.S. application Ser. No. 09/597,359, filed 19 Jun. 2000 and assigned to the assignee hereof (“First Application”);

“System and Method for Dynamic Local Caching of Web Content”, U.S. application Ser. No. 09/699,093, filed 28 Oct. 2000 and assigned to the assignee hereof (“Second Application”);

“System and Method for Multi-Tier Multi-Casting Over the Internet”, U.S. application Ser. No. 09/917,412, filed 28 Jul. 2001 and assigned to the assignee hereof (“Third Application”);

“System and Method for Secure Communication Over the Internet”, U.S. application Ser. No. 10/039,792, filed 24 Oct. 2001 and assigned to the assignee hereof (“Fourth Application”); and

“Multi-Node Network Having Common Routing Table”, International Application Number PCT/US03/18469, filed 11 Jun. 2003 and assigned to the assignee hereof (“Fifth Application”).

The present application is also related to the following provisional application:

“Hybrid SSL/IPSec Network Management System”, U.S. Provisional Application Ser. No. 60/562,357, filed 15 Apr. 2004, and which names me as sole inventor of any inventions disclosed therein.

### BACKGROUND OF THE INVENTION

1. Technical Field

My invention relates generally to a method and apparatus for managing a distributed intranet over the Internet.

2. Background Art

In general, in the descriptions that follow, I will italicize the first occurrence of each special term of art which should be familiar to those skilled in the art of network communication systems. In addition, when I first introduce a term that I believe to be new or that I will use in a context that I believe to be new, I will bold the term and provide the definition that I intend to apply to that term. In addition, throughout this description, I may use the terms assert and negate when referring to the rendering of a signal, signal flag, status bit, or similar apparatus into its logically true or logically false state, respectively.

In the Related Applications, I related, among other things, the following:

While the number of single entity intra-nets continually increases, most multi-site entities utilize public networks for inter-site transactions. Since the Internet is the best known of the public networks, I will tend to refer to it hereafter (or to its alter ego, the World Wide Web (“WWW”) or just Web) for purposes of example. However, numerous Internet service providers or ISPs have set up their privately-owned networks so as to be semi-autonomous from the remainder of the Internet, thereby allowing their subscribers to exploit the many advantages inherent in such intra-ISP communication facilities. For my purposes, therefore, I intend the term “public network” to include any network to which a member of the public, in my case any business entity, can obtain access by payment of a periodic service fee. Thus, I distinguish such intra-ISP-networks from truly private networks that are owned and operated by single organizations, such as large corporations, and to which access is limited to only members (e.g., employees) of that organization (these I will refer to as “iNets”). For purposes of this application, I shall refer hereinafter to an employee connected to an iNet as if she were a client of the business systems that have been fully and completely disclosed in the First, Second, Third and Fourth Applications.

As I explained in my Third Application, Transmission Control Protocol (“TCP”) is a method used along with the Internet Protocol (“IP”) to send data in the form of message units, called packets, between computers over the Internet. TCP is known as a connection-oriented protocol, which means that a connection is established and maintained until such time as the message or messages to be exchanged by the application programs at each end have been exchanged. While IP handles the actual delivery of the data, TCP keeps track of the individual packets into which a message is divided for efficient routing through the Internet. TCP is responsible both for ensuring that a message is divided into the packets that IP manages, and for reassembling the packets back into the complete message at the other end. For example, when a live cast is transmitted from a content server, the TCP program layer in that server divides the continuous audio/video stream into a series of packets, sequentially numbers those packets, and then forwards them individually to the IP program layer. Although each packet has the same destination IP address, it may get routed differently through the Internet. At the receiving computer, TCP reassembles the individual packets and waits until all have arrived to forward them to the application program as a single, contiguous file.

The objective of TCP is to provide a reliable, connection-oriented delivery service. TCP views data as a stream of bytes, not frames. The unit of transfer is referred to as a segment. To provide the connection-oriented service, TCP takes care to ensure reliability, flow control, and connection maintenance. TCP is able to recover from data that is damaged, lost, duplicated, or delivered out of sequence. In order to do this, the content server's TCP assigns a sequence number to each byte to be transmitted. For each byte received, the client server's TCP must return an Acknowledge (“ACK”) within a specified period. If this is not done, the content server will retransmit the data. Damaged data is handled by adding a checksum to each segment. If a segment is detected as damaged by the client server's TCP, it will discard the segment and return no ACK. Receiving no ACK, the content server will automatically resend the segment.

User Datagram Protocol (“UDP”) is a communications method that offers a limited amount of service when messages are exchanged between computers in a network that uses IP. Like TCP, UDP uses IP to actually get a data unit (called a datagram) from a content server to a client server. Unlike TCP, however, UDP does not provide the service of dividing a message into packets and reassembling it at the other end. Specifically, UDP doesn't provide sequencing of the data packets. This means that an application program that uses UDP must be able to make sure that the entire message has arrived and is in the correct order. UDP provides two services not provided by the IP layer: port number to help distinguish different user requests, and, optionally, a checksum capability to verify that the data arrived intact.

A virtual private network (“VPN”) is a private data network that makes use of the public telecommunication infrastructure, maintaining privacy through the use of a tunneling protocol and security procedures. A VPN can be contrasted with a system of owned or leased lines that can only be used by one company. The idea of the VPN is to give the company the same capabilities at much lower cost by using the shared public infrastructure rather than a private one. In theory, a VPN facilitates sharing of public resources for the secure exchange of private data. One major use of VPN is to enable secure communications between client servers connected to different, remotely located segments of a distributed iNet. For convenience of reference, I refer to the set of commonly owned client servers connected to a single, corporate-wide iNet as siblings.

Using a VPN involves encrypting data before sending it through the public network and decrypting it at the receiving end. An additional level of security involves encrypting not only the data but also the originating and receiving network addresses. VPN software is typically installed as part of a company's firewall server. Several secure protocols have been proposed to create a VPN using tunnels through the Internet. Each tunnel is the particular path that a given company message or file might travel through the Internet. Using such protocols, any employee having a PC with VPN client support will be able to use any ISP to connect securely to the employer's server. This means that companies will no longer need their own leased lines for wide-area communication but could securely use the public networks.

One primary function of a firewall is to render invisible from the Internet side all client servers that may be connected to the iNet side. I prefer to think of such client servers as being cloaked by the firewall. One consequence of being cloaked is that a VPN can be initiated only by a cloaked client server. Accordingly, special procedures are required before a sibling client server connected to a remotely located segment of that iNet (or perhaps a mobile client server that is connected to the Internet via a temporary public connection) will be allowed to initiate a VPN with a cloaked client server. This problem is further exacerbated if the sibling client server is itself cloaked by a second firewall. In my Fourth Application I disclose a general solution to secure communications between cloaked, sibling client servers and their respective clients.

In a typical iNet comprising multiple client servers organized into multiple tiers, a selected one of the servers, located at the logical root of the tree-like structure, is tasked with maintaining a master routing table (“RT”) that must be constantly updated to reflect the status of each node in the structure. In such an arrangement all intra-net traffic must be routed by the root server. As a result, the entire system to vulnerable to catastrophic failure in the event the root server goes down. For reasons of system reliability, it would be preferable to provide a more distributed mechanism for maintaining the RT.

In a typical multi-partition iNet, in which the iNet is partitioned into a plurality of interconnected sub-nets, each partition is managed by a respective partition server. Depending upon the size of the iNet, one or more higher levels of multi-partition servers may be provided to manage increasing larger combinations of sub-nets. At each level, one or more respective partition servers maintain the respective RTs for their sub-nets. In such an arrangement, the loss of one of the partition servers results in the effective loss of the entire sub-net until some higher lever partition server finally succeeds in reestablishing communication with the surviving nodes of that sub-net. To minimize system recovery time, it would be preferable to provide a mechanism whereby a single master RT is coherently maintained within each server, thereby facilitating, in the event of loss of any one or more of the partition servers, rapid reconstruction of the balance of the iNet by the remaining partition servers.

In the typical multi-tiered iNet wherein a plurality of servers are each responsible for managing a respective portion of the system RT, the workload on each server just to manage the RT increases rapidly as the total number of nodes in the structure varies over time (e.g., due to new machines coming on-line while others go off-line). This workload will be further increased if, in addition to reflecting simply node membership, the RT maintains node operating history information. For reasons of system workload management, it would be preferable to provide a more efficient mechanism for sharing the burden of maintaining the RT. In my Fifth Application, I disclose a system and method for coherently managing a distributed RT.

Now, since the filing of my Related Applications, I have come to realize that, in addition to the deficiencies and problems related above, the following deficiencies and problems are present in currently-available Internet-based distributed video/audio surveillance systems:

1. One leading VPN protocol contender for use in distributed intranets is IP Security (“IPSec”). In general, IPSec, operating as it does at the network layer, is ideal for use between geographically distributed, fixed sites. Furthermore, IPSec is well adapted to transport both TCP and UDP packet traffic. A good overview of IPSec is set forth in “Dynamic VPN's Achieving Scalable, Secure Site-to-Site Connectivity: How to replace WAN connections with a more reliable communication infrastructure,” and “How different Approaches to Site-to-Site VPNs Affect Scalability and Connectivity”, both by NetScreen Technologies, Inc. (copies of which are submitted herewith and expressly incorporated herein in their entirety by reference). One drawback of IPSec is the level of human intervention required to set up and maintain the end-points of an IPSec tunnel. This issue quickly becomes a major issue if the IP address of end-points are, for any of a number of legitimate reasons, assigned dynamically. Such a situation could occur, for example, if an IPSec tunnel end-point is located behind a firewall that is configured to dynamically remap incoming static IP addresses to respective internal dynamic IP addresses.

2. The other leading VPN protocol contender is Secure Socket Layer (“SSL”). In contrast to IPSec, SSL, a service built into all modern browsers, is preferable for use between fixed sites and mobile units. Unlike IPSec, SSL works just fine from behind firewalls, as it is specially designed to adapt to dynamically assigned IP addresses. On the other hand, SSL is not suitable for transporting UDP packet traffic.

3. In view of the relative strengths and weaknesses of IPSec vis-à-vis SSL, users have, in the past, been forced to choose either one or the other based on a number of criteria. An excellent discussion of the relevant issues is set forth in “VPN Decision Guide: IPSec or SSL VPN Decision Criteria”, a technology white paper by NetScreen Technologies, Inc., 17 Feb. 2004 (a copy of which is submitted herewith and expressly incorporated herein in its entirety by reference).

4. In certain critical applications like geographically distributed video/audio surveillance systems, the selection of VPN protocol, either IPSec or SSL, has significant secondary ramifications. In particular, manufacturers of Internet-ready camera systems tend to design their products to implement, if at all, only one of the two packet-transport protocols, i.e., TCP or UDP. Thus, a user who has selected, say, the SSL VPN protocol is, as a side-effect, restricted to selecting camera systems from among those that are TCP-enabled. If, instead, that same user had selected the IPSec VPN protocol, then even non-real-time data transfers (such as up-load of off-line-recorded DVR files) would be forced to use the less bandwidth efficient IPSec VPN protocol.

In these prior art distributed network management systems, system security and data integrity must be balanced against, on the one hand, the cost of increased human intervention, or, on the other hand, restricted implementation options. What is needed is a system that has the security and data protocol flexibility inherent in a IPSec-based distributed network management system, but with the bandwidth efficiency and low overhead of an SSL-based network management system.

### BRIEF SUMMARY OF THE INVENTION

In accordance with a preferred embodiment of my invention, I provide a method for managing a secure distributed network using an SSL VPN to establish and manage an IPSec VPN.

### BRIEF DESCRIPTION OF THE SEVERAL VIEWS OF THE DRAWINGS

My invention may be more fully understood by a description of certain preferred embodiments in conjunction with the attached drawings in which:

FIG. 1 illustrates in block diagram form a business system adapted to provide a virtual VPN (“VVPN”) as generally set forth in my Related Applications;

FIG. 2 illustrates in block diagram form an iNet configured as a ring of stars (“RoS”) which is managed using a common routing table (“CRT) as set forth in my Fifth Application;

FIG. 3 illustrates in block diagram form an SSL VPN iNet configured as a ring of stars (“RoS”) which is managed using a common key table (“CKT) containing the Public SSL Keys of all nodes of the SSL VPN iNet, as set forth in the present application;

FIG. 4 illustrates in block diagram form the ability of the SSL VPN iNet of FIG. 3 to support direct peer-to-peer connectability;

FIG. 5 illustrates in block diagram form an IPSec VPN iNet configured as a ring of stars (“RoS”) which is managed using a set of distributed IPSec key tables (“DKT), each containing the Pre-Shared IPSec Keys of such other nodes of the IPSec VPN iNet as may be visible to each respective node, as set forth in the present application;

FIG. 6 illustrates in time flow diagram form the process for maintaining coherency of the common key table between the server nodes comprising the RoS shown in FIG. 3 (“Case 1”); and

FIG. 7 illustrates in time flow diagram form the process for maintaining coherency of the common key table between the master server and the various mobile clients comprising the RoS shown in FIG. 3 (“Case 2”).

### DETAILED DESCRIPTION OF THE INVENTION

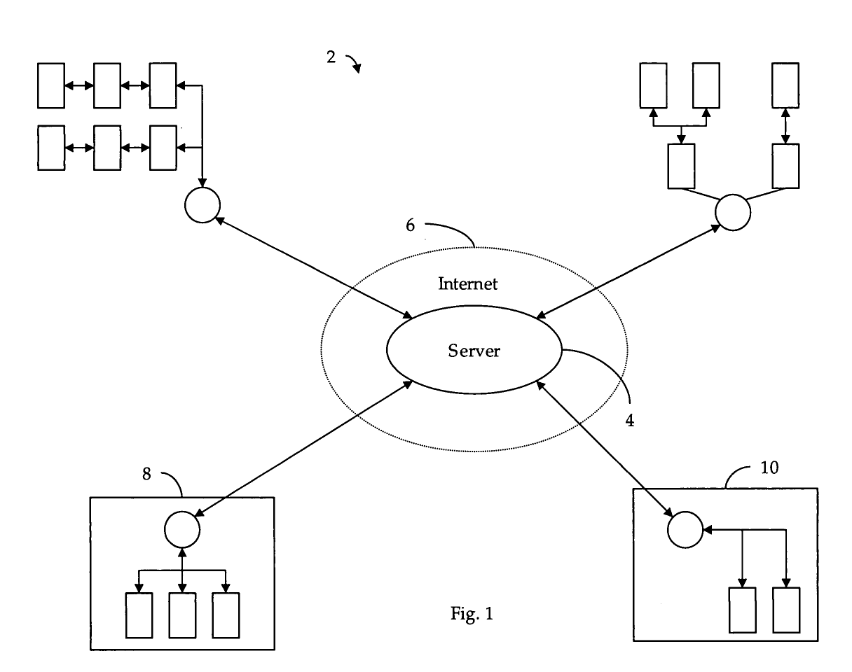

Shown in FIG. 1 is a business system 2 having a server 4 that can be accessed electronically via the Internet 6 by a plurality of businesses, including for example a first client 8, and a second client 10. Each member business may subscribe for any of the several services available from my server 4. A number of such services are described in my First, Second, Third, Fourth, and Fifth Applications.

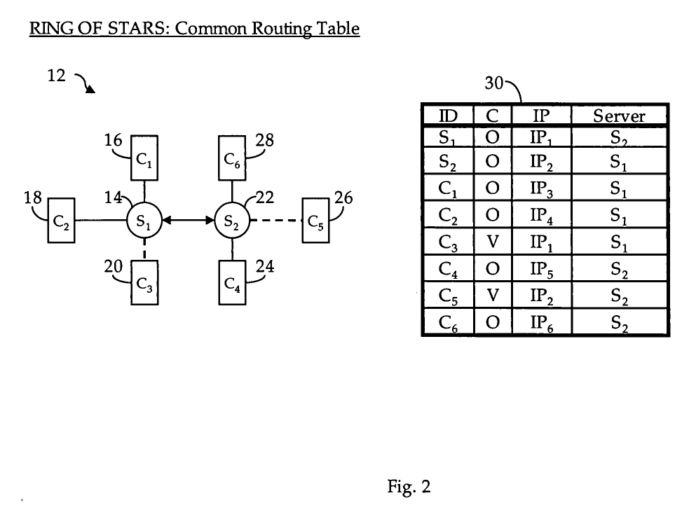

Shown in FIG. 2 is a multi-node iNet configured as a ring of stars that I shall refer to as RoS 12. In RoS 12, a first server, S₁ 14, provides, at a minimum, services to three (3) clients, C₁ 16, C₂ 18 and C₃ 20, and a second server, S₂ 22, provides, at a minimum, services to three (3) clients, C₄ 24, C₅ 26 and C₆ 28. In my Fifth Application, I have described how a common routing table 30 can be used to dynamically distribute the server workload among the several servers.

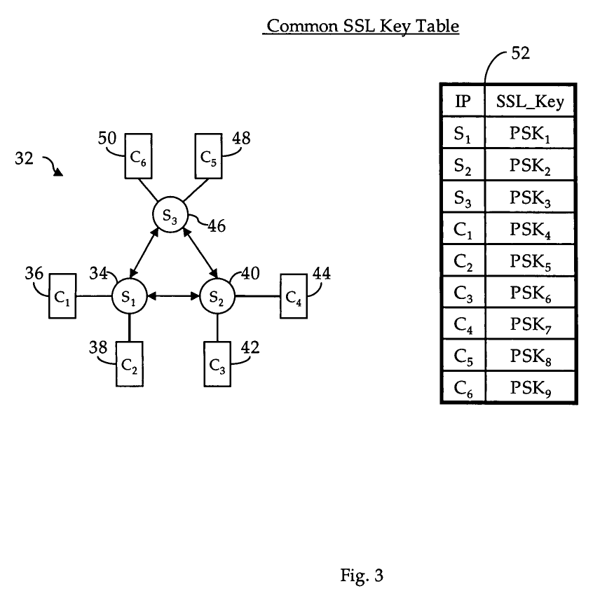

Shown in FIG. 3 is a multi-node iNet configured as a ring of stars that I shall refer to as RoS 32. In RoS 32, a first server, S₁ 34, provides, at a minimum, services to two (2) clients, C₁ 36 and C₂ 38, a second server, S₂ 40, provides, at a minimum, services to two (2) clients, C₃ 42 and C₄ 44, and a third server, S₃ 46, provides, at a minimum, services to two (2) clients, C₅ 48 and C₆ 50. Using the same process as described in my Fifth Application to maintain the common routing table 30, I can maintain a common SSL key table 52.

In accordance with the SSL standard, each node in a network will automatically generate a random Public/Private SSL Key pair during an initial SSL session. The Private SSL Key will be maintained locally within each node, and will not be shared with other nodes, whereas the Public SSL Key will be shared with all other nodes. Thus, for example, a first node can request an initial SSL VPN session with a second node by first generating a random SSL Public/Private Key pair, storing the Private SSL Key, and transmitting to the second node the Public SSL Key of the first node. In response, the second node will register the Public SSL Key of the first node. Since, by assumption, this is the initial SSL session of the second node, that node will then generate its random Public/Private SSL Key pair, store the Private SSL Key, and transmit back to the first node the Public SSL Key of the second node. In response, the first node will register the Public SSL Key of the second node. Thereafter, the first node will encode transactions transmitted to the second node using the Public SSL Key of the second node, and the second node will encode transactions transmitted to the first node using the Public SSL Key of the first node. I recommend that each node periodically regenerate its Public/Private SSL Key pair and then register the new Public SSL Key during subsequent SSL sessions with other nodes. Although many modern browsers include SSL functionality, I prefer the open source SSL software package available from the OPENSSH group (www.openssh.org).

As can be seen in FIG. 3, my common SSL key table 52 is comprised of an entry for each of possible connection paths between the three (3) servers, namely S₁ 34, S₂ 40, and S₃ 46, and the six (6) clients, namely, C₁ 36, C₂ 38, C₃ 42, C₄ 44, C₅ 48 and C₆ 50. Thus, in the network configuration shown in FIG. 3, the common SSL key table 52 will include nine (9) entries:
1. Entry one comprises two (2) fields: the IP address for the first server, S₁ 34, and the Public SSL Key, PSK₁, that has been generated for use by the first server, S₁ 34, during subsequent SSL sessions.
2. Entry two comprises two (2) fields: the IP address for the second server, S₂ 40, and the public SSL key, PSK₂, that has been generated for use by the second server, S₂ 40, during subsequent SSL sessions.
3. Entry three comprises two (2) fields: the IP address for the third server, S₃ 46, and the Public SSL Key, PSK₃, that has been generated for use by the third server, S₃ 46, during subsequent SSL sessions.
4. Entry four comprises two (2) fields: the IP address for the first client, C₁ 36, and the Public SSL Key, PSK₄, that has been generated for use by the first client, C₁ 36, during subsequent SSL sessions.
5. Entry four comprises two (2) fields: the IP address for the second client, C₂ 38, and the Public SSL Key, PSK₅, that has been generated for use by the second client, C₂ 38, during subsequent SSL sessions.
6. Entry four comprises two (2) fields: the IP address for the third client, C₃ 42, and the Public SSL Key, PSK₆, that has been generated for use by the third client, C₃ 42, during subsequent SSL sessions.
7. Entry four comprises two (2) fields: the IP address for the fourth client, C₄ 44, and the Public SSL Key, PSK₇, that has been generated for use by the fourth client, C₄ 44, during subsequent SSL sessions.
8. Entry four comprises two (2) fields: the IP address for the fifth client, C₅ 48, and the Public SSL Key, PSK₈, that has been generated for use by the fifth client, C₅ 48, during subsequent SSL sessions.
9. Entry four comprises two (2) fields: the IP address for the sixth client, C₆ 50, and the Public SSL Key, PSK₉, that has been generated for use by the sixth client, C₆ 50, during subsequent SSL sessions.

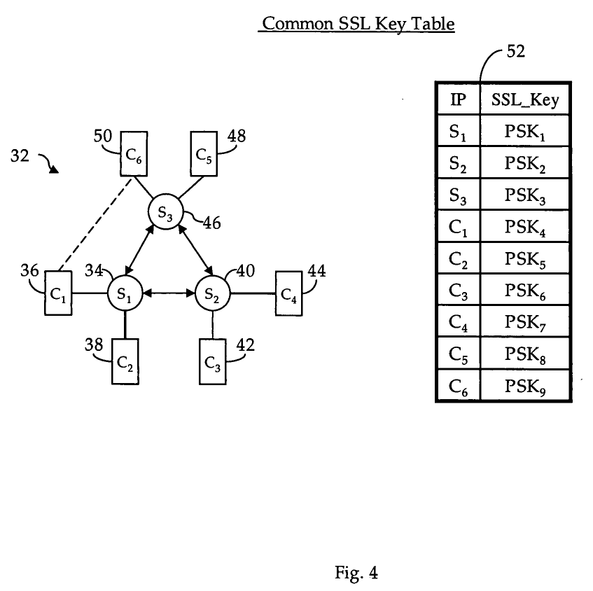

Using my common SSL key table 52, any node in the iNet can immediately establish a direct peer-to-peer SSL VPN with any other node. Thus, as shown by way of example in FIG. 4, the first client, C₁ 36, can easily and quickly establish a direct peer-to-peer SSL VPN with the sixth client, C₆ 50, since the common SSL key table 52 contains each node's respective registered Public SSL Key, namely, PSK4 and PSK9.

Although, in accordance with the IPSec standard, the nodes in an IPSec network can employ Public/Private Key pairs, I prefer to use Pre-Shared IPSec Keys. Although various software packages are available to implement the IPSec functionality, I prefer the open source IPSec software package available from the Linux FreeS/WAN group (www.freeswan.org).

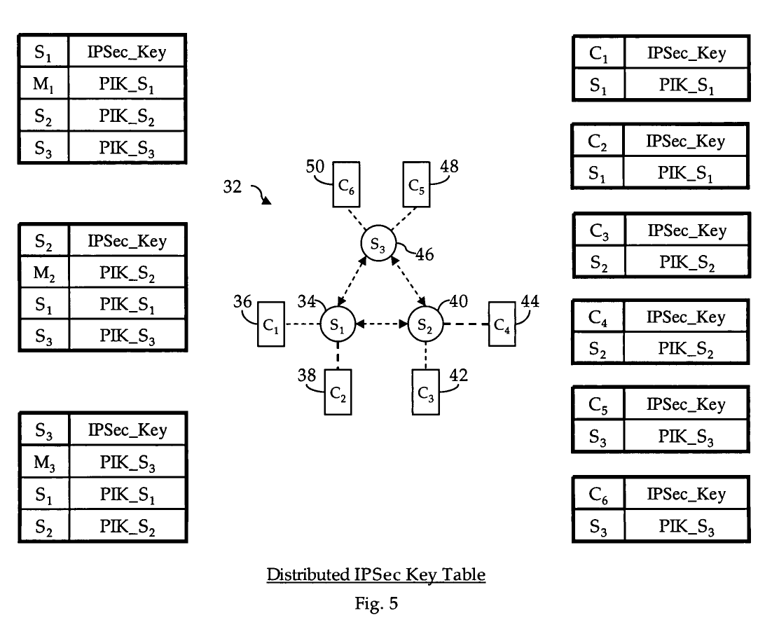

In accordance with the preferred embodiment of my invention, I can use the same process as described in my Fifth Application, but operating over my SSL VPN network, to initially share and thereafter maintain the several Pre-Shared IPSec Keys via a distributed IPSec key table 53. As illustrated in FIG. 5, each node in the RoS 32 is adapted to store, locally, an IPSec key table segment containing a selected subset of the distributed IPSec key table 53. In general, each IPSec key table segment contains the Pre-Shared IPSec Key of only those other nodes in the RoS 32 with which the respective node is capable of establishing an IPSec VPN. Thus, for the illustrated example, the IPSec key table segment stored in the first server, S₁ 34, is comprised of three (3) entries:
1. Entry one comprises two (2) fields: the designator for a first class of mobile clients, M₁; and the Pre-Shared IPSec Key, PIK₁, that has been generated for use by the first server, S₁ 34, during subsequent IPSec sessions with “mobile” clients, such as the first client, C₁ 36, or the second client, C₂ 38.
2. Entry two comprises two (2) fields: the IP address for the second server, S₂ 40, and the Pre-Shared IPSec Key, PIK₂, that has been generated for use by the first server, S₁ 34, during subsequent IPSec sessions with the second server, S₂ 40.
3. Entry three comprises two (2) fields: the IP address for the third server, S₃ 46, and the Pre-Shared IPSec Key, PIK₃, that has been generated for use by the first server, S₁ 34, during subsequent IPSec sessions with the third server, S₃ 46.
   The IPSec key table segments stored in the second server, S₂ 40, and the third server, S₃ 46, are similarly configured, as shown. The IPSec key table segment stored in the first client, C₁ 36, is comprised of a single entry, consisting of two (2) fields: the Pre-Shared IPSec Key, PIK₁, that has been generated for use by the first server, S₁ 34, during subsequent IPSec sessions with “mobile” clients. The IPSec key table segments stored in the other clients, C₂ 38 through C₆ 50, are similarly configured, as shown. Considered as a whole, the IPSec key table segments comprising the distributed IPSec key table 53 define the range of the IPSec VPN. Thus, for example, the first client, C₁ 36, can communicate securely, using the IPSec protocol, with the sixth client, C₆ 50, via three separate and distinct IPSec VPN links: the link between the first client, C₁ 36, and the first server, S₁ 34; the link between the first server, S₁ 34, and the third server, S₃ 46; and the link between the third server, S₃ 46, and the sixth client, C₆ 50.

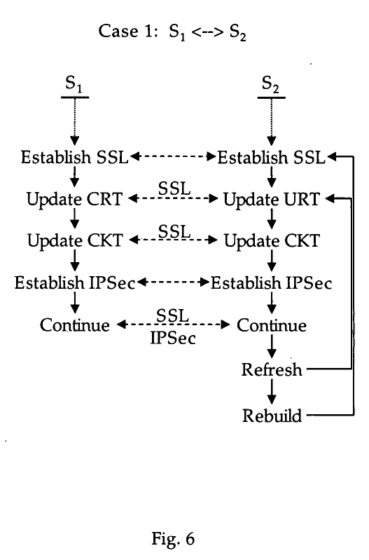

Shown in FIG. 6 is my preferred process for maintaining coherency in the common SSL key table 52 and the distributed IPSec key table 53 between the several servers in the system. In the illustrated example, the first server, S₁ 34, has been designated to maintain the master copy of the common SSL key table 52. Accordingly, at system startup, the first server, S₁ 34, will cooperate with the second server, S₂ 40, to establish an SSL VPN, using the mechanisms described in detail in my Fifth Application. Once the SSL VPN has been established, the second server, S₂ 40, will provide current status information to the first server, S₁ 34. Upon updating its master copy of the common routing table 30, the first server, S₁ 34, will cooperate with the second server, S₂ 40, to update its local copy of the common routing table 30. The same process is then used to update the master and local copies of the common SSL key table 52. Using the fresh routing and key information, the first server, S₁ 34, will then cooperate with the second server, S₂ 40, to establish an IPSec VPN, using the conventional process. Once the IPSec VPN has been established, the first server, S₁ 34 and the second server, S₂ 40, will each update its local segment of the distributed IPSec key table 53. Traffic can then flow between the servers as necessary, using either the SSL VPN or the IPSec VPN, as the case may require.

Periodically, say every five (5) minutes or so, the second server, S₂ 40, will attempt to refresh its local copies of the common routing table 30, the common SSL key table 52, and the local segment of the distributed IPSec key table 53. If, during the refresh process, the second server, S₂ 40, determines that there has been no change in either the routing or the key information for the first server, S₁ 34, then it will be assured that the existing IPSec VPN is still functional. Thus, in this situation, the second server, S₂ 40, can skip the step of establishing the IPSec VPN with the first server, S₁ 34. If for some reason the SSL VPN has been broken, the second server, S₂ 40, will then attempt to reestablish the SSL VPN. If this proves to be impossible, the second server, S₂ 40, can attempt the recovery techniques described in my Fifth Application.

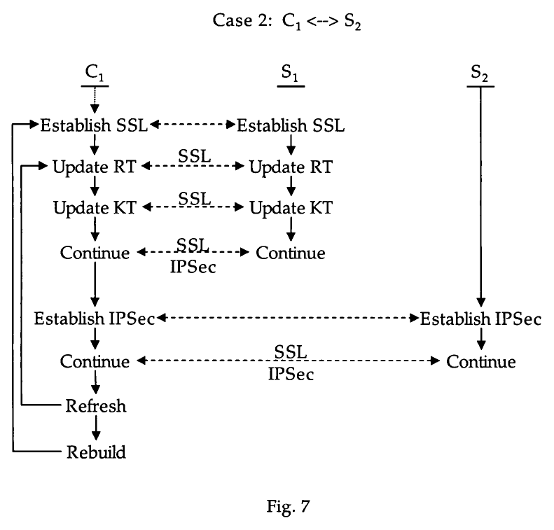

Shown in FIG. 7 is my preferred process for maintaining coherency in the common SSL key table 52 and the distributed IPSec key table 53 between the master server and the various mobile clients. In the illustrated example, the first server, S₁ 34, has been designated to maintain the master copy of the common SSL key table 52. Accordingly, when a mobile client, say the third client, C₃ 42, desires to join the VPN network, that client will cooperate with the first server, S₁ 34, to first establish an SSL VPN, using the mechanisms described in my Fifth Application. Once the SSL VPN has been established, the third client, C₃ 42, will provide current status information to the first server, S₁ 34. Upon updating its master copy of the common routing table 30, the first server, S₁ 34, will cooperate with the third client, C₃ 42, to update its local copy of the common routing table 30. The same process is then used to update the local copies of the common SSL key table 52.

Assume, for example, that the first server, S₁ 34, decides, for workload management reasons, to assign the third client, C₃ 42, to the second server, S₂ 40. Using the fresh routing information and the Public SSL Key for the second server, namely PSK₄, the third client, C₃ 42, will then cooperate with the second server, S₂ 40, to establish an IPSec VPN, using the conventional process. Once the IPSec VPN has been established, the second server, S₂ 40 and the third client, C₃ 42, will each update its local segment of the distributed IPSec key table 53. Traffic can then flow between the third client, C₃ 42, and the second server, S₂ 40, as necessary, using either the SSL VPN or the IPSec VPN, as the case may require.

Periodically, say every five (5) minutes or so, the third client, C₃ 42, will attempt to refresh its local copies of the common routing table 30, the common SSL key table 52, and the distributed IPSec key table 53. If, during the refresh process, the third client, C₃ 42, determines that there has been no change in either the routing or the key information for the second server, S₂ 40, then it will be assured that the existing IPSec VPN is still functional. Thus, in this situation, the third client, C₃ 42, can skip the step of establishing the IPSec VPN with the second server, S₂ 40. If for some reason the SSL VPN with the first server, S₁ 34, has been broken, the third client, C₃ 42, will then attempt to reestablish the SSL VPN. If this proves to be impossible, the third client, C₃ 42, can attempt the recovery techniques described in my Fifth Application.

By distributing the obligation to initiate the refresh operation, my invention tends to spread the total workload imposed on the first server, S₁ 34, more evenly over time. Of course, as I have described in my Fifth Application, the refresh operation can itself be distributed, with each server refreshing its own set of clients.

Even though I have described my invention in the context of an IPSec VPN that employs the Preshared Key mechanism, it would be easy to implement my invention in the context of IPSec VPNs that employ either the X509 Certificate or RSA Key mechanisms. Those skilled in the art will recognize that other modifications and variations can be made without departing from the spirit of my invention.

What I claim is:

1. A method for operating, via the Internet, a distributed network comprised of first and second nodes, the method comprising:
establishing, via the Internet, a first virtual private network (VPN) between said first and second nodes using a secure socket layer (SSL) protocol;
establishing, via the first VPN, a second VPN between said first and second nodes using an Internet protocol security (IPSec) protocol; and
operating the network using a selected one of the first and second VPNs.

2. The method of claim 1 wherein said first node maintains control information relating to said first VPN.

3. The method of claim 2 wherein said second node cooperates with said first node, via a selected one of the first and second VPNs, to maintain a copy of said control information in said second node.

4. The method of claim 2 wherein said first node selectively refreshes said control information relating to said first VPN.

5. The method of claim 4 wherein said second node cooperates with said first node, via a selected one of the first and second VPNs, to maintain a coherent copy of said control information in said second node.

6. The method of claim 1 wherein said first node maintains control information relating to said first and second VPNs.

7. The method of claim 6 wherein said second node cooperates with said first node, via a selected one of the first and second VPNs, to maintain a copy of said control information in said second node.

8. The method of claim 6 wherein said first node selectively refreshes said control information relating to said first and second VPNs.

9. The method of claim 8 wherein said second node cooperates with said first node, via a selected one of the first and second VPNs, to maintain a coherent copy of said control information in said second node.

10. A method for establishing, via the Internet, a first virtual private network (VPN) comprised of first and second nodes using an Internet protocol security (IPSec) protocol, the method comprising:
establishing, via the Internet, a second VPN between said first and second nodes using a secure socket layer (SSL) protocol; and
establishing, via the second VPN, said first VPN between said first and second nodes using said IPSec protocol.

11. The method of claim 10 wherein said first node maintains control information relating to said second VPN.

12. The method of claim 11 wherein said second node cooperates with said first node, via a selected one of the first and second VPNs, to maintain a copy of said control information in said second node.

13. The method of claim 11 wherein said first node selectively refreshes said control information relating to said second VPN.

14. The method of claim 13 wherein said second node cooperates with said first node, via a selected one of the first and second VPNs, to maintain a coherent copy of said control information in said second node.

15. The method of claim 10 wherein said first node maintains control information relating to said first and second VPNs.

16. The method of claim 15 wherein said second node cooperates with said first node, via a selected one of the first and second VPNs, to maintain a copy of said control information in said second node.

17. The method of claim 15 wherein said first node selectively refreshes said control information relating to said first and second VPNs.

18. The method of claim 17 wherein said second node cooperates with said first node, via a selected one of the first and second VPNs, to maintain a coherent copy of said control information in said second node.
